(19) United States
(12) Patent Application Publication
(10) Pub. No.: US 2014/0270395 A1
(43) Pub. Date: Sep. 18, 2014

(54) METHODS AND APPARATUS FOR DETERMINING INFORMATION ABOUT OBJECTS FROM OBJECT IMAGES

(71) Applicant: Propel lP, Raleigh, NC (US)

(72) Inventors: Brenda Jones, Raleigh, NC (US); Robert Jones, Raleigh, NC (US)

(73) Assignee: Propel lP, Raleigh, NC (US)

(21) Appl. No.: 14/210,686

(22) Filed: Mar. 14, 2014

Related U.S. Application Data
(60) Provisional application No. 61/792,533, filed on Mar. 15, 2013.

(51) Int. Cl. G06T 7/00

(52) U.S. Cl. CPC G06T 7/0042
USPC 382/110

(57) ABSTRACT

Methods and apparatus for determining information about an object are provided. An image of an object is acquired, dimensional information about the object are estimated based on the image data, and weight information is determined about the object using the estimated dimensional information. The image may be displayed with the object dimensional information and/or with the object weight information. The image may be stored and/or shared with the object dimensional and weight information. In addition, other information may be entered by a user and stored and/or shared with the image. A medical condition of a person may be determined by acquiring an image of the person, estimating height and weight information for the person based on image data, and determining a medical condition using the estimated height and weight information.

### RELATED APPLICATION

This application claims the benefit of and priority to U.S. Provisional Patent Application No. 61/792,533, filed Mar. 15, 2013, the disclosure of which is incorporated herein by reference as if set forth in its entirety.

### FIELD OF THE INVENTION

The present invention relates generally to images and, more particularly, to methods and apparatus for analyzing images.

### BACKGROUND OF THE INVENTION

Many fishing enthusiasts keep a personal log of their fishing activities, including time, date and location of a fishing activity, as well as information about any fish caught, including species, weight, length, etc. Portable devices that allow fishing enthusiasts to quickly weigh and measure fish are known. For example, U.S. Pat. No. 6,765,155 describes a portable device for weighing and measuring fish. U.S. Pat. No. 6,696,650 to Muller et al. describes an electronic fish scale with a digital output screen. Unfortunately, recording data from these portable devices into a written log can be inconvenient and/or cumbersome during an outing. Moreover, written logs may omit useful details or may include inaccurate information if written after an outing.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to some embodiments of the present invention, a method of determining information about an object includes acquiring an image of the object, estimating dimensional information about the object based on image data, determining weight information about the object using estimated dimensional information, and deducing (i.e., inferring, calculating, etc.) a medical measure (BMI, waist-to-height ratio, etc.) using the estimated height and weight information. The image may be displayed with the object dimensional information and/or with the object weight information and/or with the deduced medical measure. The image may be stored and/or shared with the object dimensional and weight information. In addition, other information may be entered by a user and stored and/or shared with the image.

In some embodiments, determining weight information about the object includes identifying density information about the object.

In some embodiments, determining weight information about the object includes identifying a species of the object and obtaining density information for the species.

According to some embodiments of the present invention, a method of determining a medical condition of a person includes acquiring an image of the person, estimating height and weight information for the person based on image data, and determining a medical condition using the estimated height and weight information. The image may be displayed with the height and weight information for the person. The image may be displayed with information about the medical condition. The image may be stored and/or shared with the height, weight and/or medical condition information for the person. In addition, other information may be entered by a user and stored and/or shared with the image.

According to some embodiments of the present invention, a method of determining a medical condition of a person includes acquiring an image of the person, and analyzing the image to identify areas of fat accumulation on the person. In addition, the image may be analyzed to measure an amount of fat accumulation on the person.

According to some embodiments of the present invention, a method of determining a medical condition of a person includes acquiring an image of the person, and analyzing the image to identify a body shape of the person.

According to some embodiments of the present invention, a method of determining a medical condition of a person includes acquiring an image of the person, and comparing the image to one or more images of the person from a previous time to identify a current medical condition of the person.

According to other embodiments of the present invention, an apparatus for determining information about an object includes a camera, a processor, and a memory. The memory stores instructions that, when executed by the processor, cause the processor to perform operations including acquiring an image of the object via the camera, estimating dimensional information about the object based on data from the image, and determining weight information about the object using estimated dimensional information.

In some embodiments, the memory stores instructions that, when executed by the processor, cause the processor to display the image with estimated object dimensional information and/or display the image with estimated object weight information.

In some embodiments, the memory stores instructions that, when executed by the processor, cause the processor to store the image and the object dimensional and weight information.

In some embodiments, the memory stores instructions that, when executed by the processor, cause the processor to determine weight information about the object by identifying density information about the object and/or by identifying a species of the object and obtaining density information for the species.

According to other embodiments of the present invention, an apparatus for determining a medical condition of a creature includes a camera, a processor, and a memory. The memory stores instructions that, when executed by the processor, cause the processor to perform operations including acquiring an image of the creature, estimating height and weight information for the creature based on image data, determining a medical condition using the estimated height and weight information, and deducing a medical measure using the estimated height and weight information.

In some embodiments, the memory stores instructions that, when executed by the processor, cause the processor to display the image with estimated height and weight information for the creature, to display the image with information about the medical condition, and to display the medical measure.

According to other embodiments of the present invention, and apparatus for determining a medical condition of a person includes a camera, a processor, and a memory. The memory stores instructions that, when executed by the processor, cause the processor to perform operations including acquiring an image of the person, and analyzing the image to identify one or more medical conditions of the person.

In some embodiments, the memory stores instructions that, when executed by the processor, cause the processor to perform one or more of the following: analyze the image to identify areas of fat accumulation on the person, analyze the image to measure an amount of fat accumulation on the person, and analyze the image to identify a body shape of the person.

In some embodiments, the memory stores instructions that, when executed by the processor, cause the processor to compare the image to one or more images of the person from a previous time to identify a current medical condition of the person.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate various embodiments of the present invention. The drawings and description together serve to fully explain embodiments of the present invention.

FIGS. 1 and 2 are flow charts of operations for determining one or more dimensions and/or weight of an object using a handheld device, according to some embodiments of the present invention.

FIG. 3 is a flow chart of operations for determining one or more types of information about a person using a handheld device, according to some embodiments of the present invention.

FIG. 4 is a block diagram that illustrates details of an exemplary processor and memory that may be used to implement various functions of a handheld device, according to some embodiments of the present invention.

FIGS. 5 and 6 illustrate a handheld device capturing an image of an object, according to some embodiments of the present invention.

FIG. 7 illustrates a user interface displayed on a handheld device for determining one or more dimensions and/or weight of an object, according to some embodiments of the present invention.

FIG. 8 illustrates a user interface displayed on a handheld device for determining one or more types of information about a person, according to some embodiments of the present invention.

### DETAILED DESCRIPTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. In the figures, certain layers, components or features may be exaggerated for clarity, and broken lines illustrate optional features or operations unless specified otherwise. In addition, the sequence of operations (or steps) is not limited to the order presented in the figures and/or claims unless specifically indicated otherwise. Features described with respect to one figure or embodiment can be associated with another embodiment or figure although not specifically described or shown as such.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the various embodiments described herein. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The term “object”, as used herein, includes inanimate objects as well as living creatures (e.g., humans, animals, plants, etc.).

The terms “creature” and “subject”, as used herein, are interchangeable and include humans and animals.

The term “medical measure”, as used herein, refers to any number of physiological ratios including, but not limited to, body mass index (BMI), waist-to-height ratio, and the like.

The term “about”, as used herein with respect to a value or number, means that the value or number can vary by +/−20%, 10%, 5%, 1%, 0.5%, or even 0.1%.

The terminology used herein is for the purpose of describing particular embodiments only and is not intended to be limiting to other embodiments. As used herein, the singular forms “a”, “an” and “the” are intended to include the plural forms as well, unless the context clearly indicates otherwise. As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Exemplary embodiments of the present invention may be embodied as methods, devices, and/or computer program products. Accordingly, exemplary embodiments of the present invention may be embodied in hardware and/or in software (including firmware, resident software, micro-code, etc.). Furthermore, exemplary embodiments of the present invention may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, or transport the program for use by or in connection with the instruction execution system, apparatus, or device.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a handheld device (e.g., a smart phone, a mobile cellular phone, a camera, a tablet computer, etc.), a general purpose computer circuit, a special purpose computer circuit, and/or other programmable data processing circuit to produce a machine, such that the instructions, which execute via the processor of the handheld device, computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a handheld device, a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a handheld device, a computer and/or other programmable data processing apparatus to cause a series of operational steps to be performed on the handheld device, computer and/or other programmable apparatus to produce a computer-implemented process such that the instructions which execute on the handheld device, computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Some embodiments of the present invention facilitate obtaining an image of an object via a handheld or portable device, and then determining various dimensions and/or characteristics of the object such as height, length, weight, density, and the like. In some embodiments, an identification of the object can be determined based upon image information and/or dimensional/characteristic information that is determined using image information. Exemplary devices that can be utilized to implement the various methods of the present invention include, but are not limited to, smart phones, tablets, computers, stand-alone digital cameras, and other hand held devices, electronic devices or camera related devices. Collectively, these devices are referred to herein as a “handheld” device.

Referring to FIGS. 1 and 2, operations for determining one or more dimensions and/or weight of an object using a handheld device, according to some embodiments of the present invention, are illustrated. Initially, a user acquires an image of an object (e.g., a fish, duck, deer, other hunted game, etc.) via a handheld device camera (Block 100). For example, FIG. 5 illustrates taking an image of a fish F via a handheld device 10. Software executing on the handheld device (e.g., 10, FIG. 5) analyzes the image to determine one or more dimensions and/or weight of the object in the image (Block 110). For example, the software may be configured to make a mathematical estimate of the length and/or girth of the object, such as the fish F in FIG. 5. Using the estimated length and/or girth information, the software is configured to compute an estimated weight of the object. For example, the estimated length and/or girth information allows for the estimation of volume of the object. Once the volume is known, an estimated density of the object can be used in conjunction with the volume to determine weight.

For example, using fish as an example, the various densities of different species of fish can be tabulated and stored, or can be obtained from other sources. Upon identification of a particular species of fish, the length and girth information can be used to estimate the volume of the fish. The volume can then be used with the particular density of the species of fish to calculate a weight of the fish. Species of fish can be identified via user input and/or via species recognition software that can identify the fish species from an image.

In addition, various algorithms can be prepared for different species of fish. For example, estimations of weight of a particular species of fish (e.g., trout) may be made using a formula such as (L×G²)/800, where L is the length of a fish and G is the girth of the fish. Because of the different characteristics of fish, a different formula may be necessary to determine weight of another species (e.g., a bass), such as (L²×G)/800, where L is the length of a fish and G is the girth of the fish. Similar algorithms can be prepared for all types of fish, as well as for all types of objects.

In some embodiments of the present invention, software executing on a handheld device can determine if a species of fish in an image is generally in good health by using the estimated length, girth, and/or weight information. For example, if a fish of a particular species has a length of ten inches (10″), the fish should have a weight within a particular range if healthy. If the software determines that the weight of the fish is lower than the particular range, then a health issue is likely associated with the fish. Similarly, if the fish appears to have a weight within the predicted range, then the fish is likely in good health.

In some embodiments of the present invention, software executing on a handheld device can determine the identity of an imaged object. For example, the software can determine the species of a fish using comparative algorithms and/or database images. By facilitating the identification of species, embodiments of the present invention also can be used to help identify and/or locate invasive species and/or non-indigenous species of fish or other animals.

In some embodiments of the present invention, the software may use reference point data to make estimates of various dimensions/characteristics of an object. For example, the step of acquiring an image of an object (Block 100) may include placing a marker of known dimensions proximate the object and within the field of view of the camera (Block 102, FIG. 2). In FIG. 6, a user has placed a physical marker M of known dimensions adjacent to the fish F such that the marker is captured with the fish F in the image. Using the known dimensions of the physical marker M, the software can then determine one or more dimensions of the object captured in the image. In some embodiments, a digital or virtual marker with known dimensions can be placed within the field of view of a camera display of the handheld device.

In some embodiments of the present invention, the software may receive additional information from a user about an object and use this information to make estimates of various dimensions/characteristics of an object (Block 104, FIG. 2). For example, the software may allow a user to manually input species type of an object (e.g., species of fish F, FIG. 5, etc.). The software then uses this information in combination with the image data to determine various dimensions, weight, and/or characteristics of the object. In some embodiments, the software may request the user to confirm or input species data after an image is acquired.

The image of the object along with one or more determined dimensions, weight, and/or characteristics can then be displayed within a user interface of the device (Block 120, FIG. 1). The image and data can then be saved and or shared with others (Block 130.) For example, users can transfer images, data or measurements derived from an image and/or the image itself via wireless or physical connection of the handheld device 10 to a computer or other device. In addition, in some embodiments, images can be printed directly from the device 10 itself.

In some embodiments of the present invention, other information may be obtained and stored and/or displayed with the image. Exemplary information includes, but is not limited to, time and date information, location information, weather information, bait information, GPS coordinates, etc. For example, in some embodiments of the present invention, the handheld device 10 may include a GPS receiver and/or environmental sensor(s) configured to detect and/or measure environmental conditions in a vicinity of the handheld device 10. The environmental sensor(s) may be configured to detect and/or measure the following types of environmental information: humidity, temperature, barometric pressure, ultraviolet radiation, ozone, carbon monoxide, carbon dioxide, airborne pollution, and/or wind.

FIG. 7 illustrates a user interface 12 within a handheld device 10, according to some embodiments of the present invention. The illustrated user interface 12 displays an image 13 of an object (e.g., fish F) captured by a camera of the handheld device 10 along with various graphical user interface (GUI) controls. For example, the illustrated user interface 12 allows the user to indicate via GUI controls 14a, 14b whether or not to estimate the length of the displayed object. In addition, the illustrated user interface 12 allows the user to indicate via GUI controls 15a, 15b whether or not to estimate the height of the displayed object. An additional GUI control 16 is provided that, in response to user activation, calculates the weight of the object based upon the image information and the estimated length and height information. In the illustrated embodiment, the estimated weight of the object is displayed in display area 18.

Embodiments of the present invention are not limited to the illustrated user interface 12 in FIG. 7. The user interface 12 may have various numbers and types of GUI controls, without limitation, and the buttons may have various functions, without limitation.

Embodiments of the present invention are particularly useful for the sportsman user by allowing the user to photograph a captured fish/creature, and then make various computations regarding dimensions and/or weight of the fish/creature. Furthermore, the image and date can be stored along with date and location information for posterity.

A handheld apparatus (e.g., 10, FIG. 7) according to some embodiments of the present invention, may include stored data (and/or may be capable of accessing remotely stored data) for a variety of items such as, but not limited to, descriptions of fish, locations of fish by region, body density of fish, etc.

In other embodiments of the present invention, images of humans may be utilized to determine general or specific medical fitness. In a clinical or home setting, once a person is photographed (typically without clothes on or with limited clothes on to facilitate an unhindered view of the person's body), the software in a handheld device 10 (or another device) can determine height and weight of the person and then compute certain medical scores like body mass index (BMI) score, etc., for the person. The BMI results can then be used to make other basic medical determinations about the health of the person. Embodiments of the present invention can also determine other dimensions of a person from an image of the person and determine other body size ratios such as waist to height ratios, etc. Other medical ratios such as weight to height (BMI score), waist circumference to height, etc., that are related to the size or dimensions of a patient, can be gathered and interpreted, also. For example, a healthy person typically has a waist circumference that is less than half of the person's height. Embodiments of the present invention can quickly determine health issues associated with a person based on an analysis of various ratios, such as waist to height, weight to height, waist circumference to height, etc., that can be observed from an image.

In some embodiments, an image of a person can be analyzed to identify areas of fat accumulation on the person. For example, an image can be analyzed to determine if fat is accumulated at a person's waist, chest, back, legs, arms, etc., which can provide an indication of one or more health issues associated with the person. In addition, an image of a person can be analyzed to measure the amount of fat accumulation on the person, which can provide an indication of one or more health issues associated with the person.

In some embodiments, an image of a person can be analyzed to determine the shape of the person's body (e.g., pear shaped, apple shaped, etc.), which can provide an indication of one or more health issues associated with the person.

In some embodiments, an image of a person can be compared to older images of the person. Such comparisons can facilitate a determination of a person's progress in a medical treatment, in weight loss, etc. In addition, such image comparisons over time may facilitate the identification of medical issues that may not be readily observable in a current image of a person.

For example, referring to FIG. 3, operations for determining one or more medical conditions of a person, according to some embodiments of the present invention, are illustrated. Initially, a user acquires an image of a person via a handheld device camera (Block 200) or via a fixed camera device. Software executing on the handheld device (e.g., 10, FIG. 5) (or other device, such as a desktop computer, tablet computer, etc.) analyzes the image to determine height and/or weight of the person in the image (Block 210). For example, the software may be configured to make a mathematical estimate of the height and/or weight of the person based on the acquired image. Using the estimated height and/or weight information, the software is also configured to determine other medical conditions of the person (Block 220) and may be configured to deduce a medical measure for the person using the estimated height and/or weight information (Block 230). Exemplary medical measures include, but a re not limited to body size ratios such as waist to height ratio, weight to height ratio (BMI score), waist circumference to height ratio, and the like.

For example, FIG. 8 illustrates a user interface 12 within a handheld device 10, according to some embodiments of the present invention. The illustrated user interface 12 displays an image 13 of a person along with various graphical user interface (GUI) controls. For example, the illustrated user interface 12 allows the user to indicate via GUI controls 14a, 14b whether or not to estimate the weight of the person in the displayed image 13. In addition, the illustrated user interface 12 allows the user to indicate via GUI controls 15a, 15b whether or not to estimate the height of the person in the displayed image 13. An additional GUI control 16 is provided that, in response to user activation, calculates the BMI of the person based upon the image information and the estimated weight and height information. In the illustrated embodiment, the, estimated BMI score of the person is displayed in display area 18. Embodiments of the present invention are not limited to the illustrated user interface 12 in FIG. 8. The user interface 12 may have various numbers and types of GUI controls, without limitation, and the buttons may have various functions, without limitation.

Referring back to FIG. 3, the image 13 (FIG. 8) of the person along with height, weight, and/or other medical condition information and/or one or more medical measures can then be displayed, for example, within a user interface of the device (Block 240, FIG. 3). The image 13 and data can then be saved and or shared with others (Block 250.) For example, users can transfer images, data or measurements derived from an image and/or the image itself via wireless or physical connection of the handheld device 10 to a computer or other device. In addition, in some embodiments, images can be printed directly from the device itself.

In some embodiments of the present invention, other information may be obtained and stored and/or displayed with the image 13. Exemplary information includes, but is not limited to, time and date information, location information, GPS coordinates, etc.

FIG. 4 illustrates an exemplary processor 300 and memory 302 of a handheld device (e.g., 10, FIGS. 7-8) or other device, according to some embodiments of the present invention. The processor 300 communicates with the memory 302 via an address/data bus 304. The processor 300 may be, for example, a commercially available or custom microprocessor. The memory 302 is representative of the overall hierarchy of memory devices containing the software and data used to implement various functions of a handheld device 10 as described herein. The memory 302 may include, but is not limited to, the following types of devices: cache, ROM, PROM, EPROM, EEPROM, flash, SRAM, and DRAM.

As shown in FIG. 4, the memory 302 may hold various categories of software and data: an operating system 306, an image acquisition and display module 308, a measurement determination module 310, and an object condition determination module 312. In particular, the operating system 306 may manage the resources of a handheld device 10 and may coordinate execution of various programs (e.g., image acquisition and display module 308, measurement determination module 310, object condition determination module 312, etc.) by the processor 300. The operating system 306 can be any operating system suitable for use with a data processing system, such as IBM®, OS/2®, AIX® or z/OS® operating systems, Microsoft® Windows® operating systems, iOS®, Android®, Unix or Linux™, etc.

The image acquisition and display module 308 comprises logic for acquiring an image via a camera of a device 10 and for displaying the image in a user interface of the device 10. The image acquisition and display module 308 also comprises logic for displaying various data with an image, such as dimensional information, weight information, etc. The measurement determination module 310 comprises logic for determining dimensional information and weight information from an image, as well as from additional information provided by a user. The object condition determination module 312 comprises logic for determining a medical condition of a person (or other creature) based upon image data, height data, and/or weight data.

Computer program code for carrying out operations of processor 300 discussed herein may be written in a high-level programming language, such as Python, Java, AJAX (Asynchronous JavaScript), C, and/or C++, for development convenience. In addition, computer program code for carrying out operations of exemplary embodiments of the present invention may also be written in other programming languages, such as, but not limited to, interpreted languages. Some modules may be written in assembly language or even micro-code to enhance performance and/or memory usage. However, embodiments of the present invention are not limited to a particular programming language. It will be further appreciated that the functionality of any or all of the program modules may also be implemented using discrete hardware components, one or more application specific integrated circuits (ASICs), or a programmed digital signal processor or microcontroller.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention.

Accordingly, all such modifications are intended to be included within the scope of this invention as defined in the claims. The invention is defined by the following claims, with equivalents of the claims to be included therein.

That which is claimed is:

1. A method of determining information about an object, the method comprising:
acquiring an image of the object;
estimating dimensional information about the object based on image data; and
determining weight information about the object using estimated dimensional information.

2. The method of claim 1, further comprising displaying the image with estimated object dimensional information.

3. The method of claim 1, further comprising displaying the image with estimated object weight information.

4. The method of claim 1, further comprising storing the image and the object dimensional and weight information.

5. The method of claim 1, wherein determining weight information about the object comprises identifying density information about the object.

6. The method of claim 1, wherein determining weight information about the object comprises identifying a species of the object and obtaining density information for the species.

7. A method of determining a medical condition of a creature, the method comprising:
acquiring an image of the creature;
estimating height and weight information for the creature based on image data;
determining a medical condition using the estimated height and weight information; and
deducing a medical measure using the estimated height and weight information.

8. The method of claim 7, further comprising displaying the image with estimated height and weight information for the creature.

9. The method of claim 7, further comprising displaying the image with information about the medical condition and with the medical measure.

10. A method of determining a medical condition of a person, the method comprising:
acquiring an image of the person; and
analyzing the image to identify one or more medical conditions of the person.

11. The method of claim 10, wherein analyzing the image to identify one or more medical conditions of the person comprises analyzing the image to identify areas of fat accumulation on the person.

12. The method of claim 10, wherein analyzing the image to identify one or more medical conditions of the person comprises analyzing the image to measure an amount of fat accumulation on the person.

13. The method of claim 10, wherein analyzing the image to identify one or more medical conditions of the person comprises analyzing the image to identify a body shape of the person.

14. The method of claim 10, wherein analyzing the image to identify one or more medical conditions of the person comprises comparing the image to one or more images of the person from a previous time to identify a current medical condition of the person.

15. An apparatus for determining information about an object, the apparatus comprising:
a camera;
a processor; and
a memory that stores instructions that, when executed by the processor, cause the processor to perform operations comprising:
acquiring an image of the object via the camera;
estimating dimensional information about the object based on data from the image; and
determining weight information about the object using estimated dimensional information.

16. The apparatus of claim 15, wherein the memory stores instructions that, when executed by the processor, cause the processor to display the image with estimated object dimensional information.

17. The apparatus of claim 15, wherein the memory stores instructions that, when executed by the processor, cause the processor to display the image with estimated object weight information.

18. The apparatus of claim 15, wherein the memory stores instructions that, when executed by the processor, cause the processor to store the image and the object dimensional and weight information.

19. The apparatus of claim 15, wherein the memory stores instructions that, when executed by the processor, cause the processor to determine weight information about the object by identifying density information about the object and/or by identifying a species of the object and obtaining density information for the species.

20. An apparatus for determining a medical condition of a creature, the apparatus comprising:
a camera;
a processor; and
a memory that stores instructions that, when executed by the processor, cause the processor to perform operations comprising:
acquiring an image of the creature via the camera;
estimating height and weight information for the creature based on image data;
determining a medical condition using the estimated height and weight information; and
deducing a medical measure using the estimated height and weight information.

21. The apparatus of claim 20, wherein the memory stores instructions that, when executed by the processor, cause the processor to display the image with estimated height and weight information for the creature, to display the image with information about the medical condition, and to display the medical measure.

22. An apparatus for determining a medical condition of a person, the apparatus comprising:
a camera;
a processor; and
a memory that stores instructions that, when executed by the processor, cause the processor to perform operations comprising:
acquiring an image of the person; and
analyzing the image to identify one or more medical conditions of the person.

23. The apparatus of claim 22, wherein the memory stores instructions that, when executed by the processor, cause the processor to perform one or more of the following:
analyze the image to identify areas of fat accumulation on the person;
analyze the image to measure an amount of fat accumulation on the person; and
analyze the image to identify a body shape of the person.

24. The apparatus of claim 22, wherein the memory stores instructions that, when executed by the processor, cause the processor to compare the image to one or more images of the person from a previous time to identify a current medical condition of the person.
